(19) United States
(12) Patent Application Publication
(10) Pub. No.: US 2026/0129619 A1
(43) Pub. Date: May 7, 2026

(54) TELECOMMUNICATIONS SYSTEM

(71) Applicant: GM GLOBAL TECHNOLOGY OPERATIONS LLC, Detroit, MI (US)

(72) Inventors: Chuan Li, Troy, MI (US); Fan Bai, Ann Arbor, MI (US); Sheng Liu, Novi, MI (US)

(73) Assignee: GM GLOBAL TECHNOLOGY OPERATIONS LLC, Detroit, MI (US)

(21) Appl. No.: 18/934,692

(22) Filed: Nov. 1, 2024

(51) Int. Cl. H04W 72/04

(52) U.S. Cl. CPC H04W 72/04

(57) ABSTRACT

A method for operating a cellular telecommunication system for communication with user equipment includes operating in a first mode and a second mode, the second mode being a backup or supplement for communications in the first mode. The method also includes adding one or more secondary cell groups operating in a third mode and after adding the one or more secondary cell groups, communicating in the first mode, the second mode, and the third mode. The first mode may have a higher average downlink throughput than the second mode. Further, the secondary cell groups may operate at a higher average downlink throughput than the first mode and the second mode. The first mode may be a fifth-generation (“5G”) sub-6 gigahertz (“sub-6”) communication mode, the second mode may be a Long-Term Evolution (“LTE”) communication mode, and the secondary cell groups may operate in a millimeter wave (“mmWave”) communication mode.

### INTRODUCTION

This disclosure is in the field of telecommunications systems.

In a fifth generation (“5G”) cellular telecommunication system, communication of user data may primarily be accomplished through 5G communication. In addition to connection via 5G, user equipment (“UE”) may simultaneously be connected via fourth generation Long-Term Evolution (“LTE”), to enhance overall system capacity and reliability.

The primary mode of 5G communication may in some instances be below 6 gigahertz (“sub-6”). However, under certain circumstances, cell groups may be added that operate in millimeter wave mode (“mmWave”), a 5G mode that may provide higher average downlink speed. The inventors have noted, however, that when a mmWave secondary cell group is added, communications quality may be reduced until connection with the mmWave secondary cell group is accomplished and communication established and stabilized. Such reduction in quality may be due to scheduling and resource allocation, rather than by varying channel conditions or environmental factors, and may occur even when the user equipment is stationary at a fixed location. The reduction in quality may be a disadvantage in a system where timely and reliable communication is important. Further, connection of mmWave communication in current systems may occur even if the user equipment does not need it, as long as signal conditions for mmWave communication are sufficient; it may be that the disruption associated with establishing mmWave communication will actually result in reduced communication quality, for at least a period of time.

Further, operation of cellular telecommunications systems may be enhanced by valuable operational information that user equipment may supply.

### SUMMARY

A method for operating a cellular telecommunication system for communication with user equipment includes operating in a first mode and a second mode, the second mode being a backup or supplement for communications in the first mode. The method also includes adding one or more secondary cell groups operating in a third mode and after adding the one or more secondary cell groups, communicating in the first mode, the second mode, and the third mode. The first mode may have a higher average downlink throughput than the second mode. Further, the secondary cell groups may operate at a higher average downlink throughput than the first mode and the second mode. The first mode may be a fifth-generation (“5G”) sub-6 gigahertz (“sub-6”) communication mode, the second mode may be a Long-Term Evolution (“LTE”) communication mode, and the secondary cell groups may operate in a millimeter wave (“mmWave”) communication mode.

In the method for operating a cellular telecommunication system, the estimated time of connection may be a function of Ps, Pe, and v, where Ps is a location where the user equipment provides a measurement report to telecommunications system, Pe is a location where the user equipment releases at least one mmWave cell, and v is an average velocity of the user equipment. Alternatively, the estimated time of connection may be a function of Pc, Pe, Pi and v, where Pc is a location where the user equipment receives a millimeter-wave measurement configuration, Pe is a location where the user equipment releases at least one mmWave cell, Pi is a location where the user equipment enters mmWave coverage, and v is an average velocity of the user equipment

In the method for operating a cellular telecommunication system, the first mode may carry control plane data used to control the telecommunications system and first user plane data of the user equipment. The second mode may carry second user plane data of the user equipment. The third mode may carry third user plane data of the user equipment. The cellular telecommunication system may comprise a plurality of base stations. Further, the user equipment may be mobile.

In a second method for operating a telecommunications system, the system includes a plurality of base stations. The method includes, through user equipment, estimating a time of connection of the user equipment to the telecommunications system in a first communications mode. The method also includes, if the estimated time of connection is below a threshold and the user equipment is not connected to the telecommunication system in the first mode, rejecting a request from the telecommunication system to the user equipment for the user equipment to connect to the telecommunication system in the first communications mode. Further, the method includes if the user equipment is connected to the telecommunications system, providing a request, using the estimated time of connection, to the telecommunications system regarding one or more operations of the telecommunications system.

The one or more operations may include addition of a secondary cell group. The one or more operations may include modification of a secondary cell group. The one or more operations may include release of a secondary cell group. The first communications mode may be 5G millimeter wave.

The method may also include, through the user equipment, feeding back application layer data of the user equipment to at least one of the base stations and through the at least one base station, using the application layer data to control a quality of service flow in the cellular telecommunication system. The method may also include, through the at least one base station, allocating communication resources among multiple communication modes. The communication modes may include LTE, 5G sub-6 and 5G millimeter wave.

A vehicle includes user equipment operable for communication via a telecommunications system. The vehicle further includes a controller programmed with and operable to execute the following instructions: estimate a time of connection of the user equipment to the telecommunications system in a first communications mode; if the estimated time of connection is below a threshold and the user equipment is not connected to the telecommunication system in the first mode, reject a request from the telecommunication system to the user equipment for the user equipment to connect to the telecommunication system in the first communications mode; and if the user equipment is connected to the telecommunications system in the first communications mode, provide a request, using the estimated time of connection, to the telecommunications system regarding one or more operations of the telecommunications system. The first communications mode may be 5G millimeter wave. The one or more operations may include secondary cell group addition (“SCGA”).

The controller may be further programmed with and operable to execute an instruction to feed back application layer data of the user equipment to the telecommunications system.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 is a telecommunications system and a vehicle communicating via the telecommunications system.

FIG. 2 illustrates communications occurring in LTE, 5G sub-6 GHZ and 5G millimeter wave modes.

FIG. 3 further illustrates communications occurring in LTE, 5G sub-6 GHZ and 5G millimeter wave modes.

FIG. 4 illustrates a user-equipment-aided resource allocation method for the telecommunications system.

FIG. 5 further illustrates the user-equipment-aided resource allocation method.

FIG. 6 illustrates a method for estimating time during which user equipment may be connected to a 5G millimeter wave network.

### DETAILED DESCRIPTION

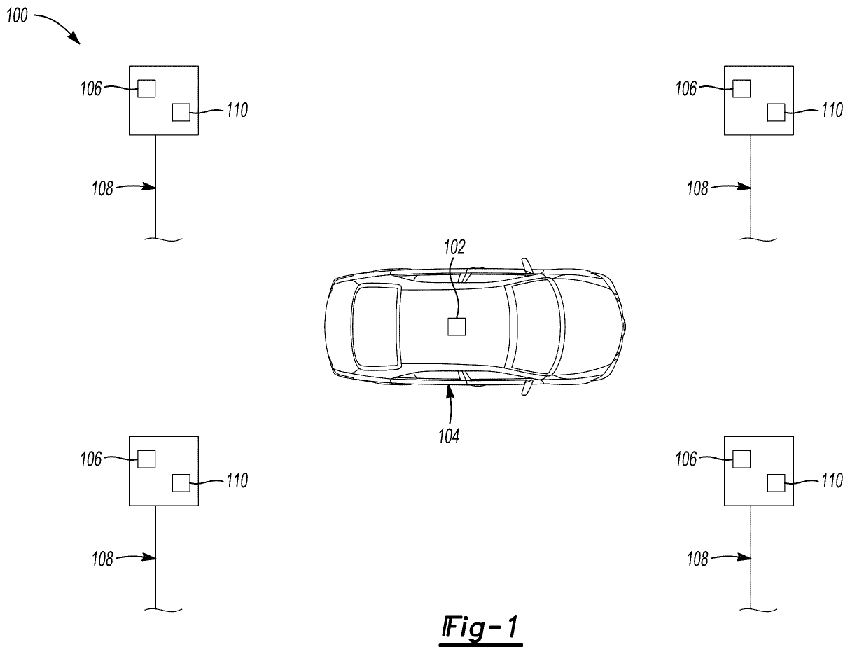

Referring first to FIG. 1, a telecommunications system 100 is illustrated. Telecommunications system 100 may be a cellular telecommunications system. FIG. 1 also illustrates user equipment 102 that may communicate via telecommunications system 100. User equipment (“UE”) 102 may be mobile. User equipment 102 may be a cellular handset telephone. User equipment 102 may be a cellular telecommunications control unit (“TCU”) installed in a vehicle 104. Vehicle 104 may be any type or model of vehicle, such as a car, truck, van, sport-utility vehicle, boat, airplane, motorcycle, or others.

Telecommunications system 100 may further include a plurality of base stations 106. Base stations 106 may be included in or near cellular towers 108, which towers may also include antennas 110. A base station 106 may act as a base station for a fifth-generation (“5G” or new radio (“NR”)) network, a fourth-generation (“4G”) Long-Term-Evolution (“4G LTE” or “LTE”) network, or even for a network of each technology. “5G” and “LTE” may be referred to as communication modes, cellular communication modes or as wireless communication modes.

Telecommunications system 100, under the supervision of base stations 106, may operate in multiple modes. Telecommunications system 100 may, as noted above, operate in 5G or NR mode. Telecommunications system 100 may also be capable of operating in Long-Term Evolution (“LTE”) mode. Further, the 5G operation may be in either a relatively-lower frequency mode (e.g., below 6 gigahertz (“sub-6”) and millimeter wave (“mmWave”), a relatively higher frequency mode that may operate above 24 gigahertz). mmWave operation may have higher average downlink speeds than sub-6, which may in turn have higher average downlink speeds than LTE.

A base station 106 may act as a base station for a 5G network, an LTE network, or even for a network of each technology.

Predominant operation of a 5G system may be in sub-6 mode. As a back-up or supplement, the 5G system may also employ LTE to enhance the throughput of the system under certain conditions. User data, such as voice data and other data being sent or received by user equipment 102, may be carried in a “user plane” of the system. The user plane data may predominantly be carried in sub-6 mode. As noted, LTE may back-up or supplement the throughput of user-plane date. LTE may also be primarily or exclusively responsible for carrying “control plane” data, that is, data used to control operation of the telecommunications network and which is distinguished from user plane data. LTE may be employed as a less resource-costly way to carry such control plane data because of the lower data rates typically needed for that data relative to higher data rates that may be needed for user-plane data.

In a 5G network, secondary cell groups may be added in order enhance data throughput. Those secondary cell groups may comprise one or more mmWave cells. They may be small cells.

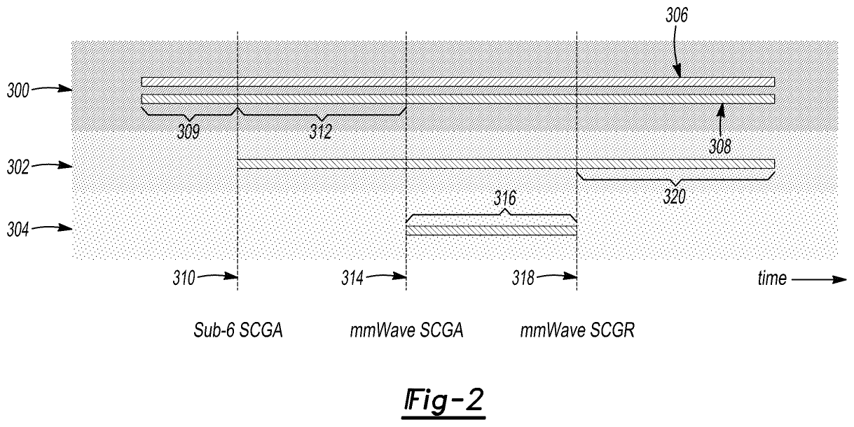

Refer to FIG. 2. There, interaction among LTE, sub-6, and mmWave modes is illustrated. Illustrated there are LTE mode 300, sub-6 mode 302, and mmWave mode 304. Control plane data 306 may be carried in LTE mode 300. First user plane data 308 may be also carried in LTE mode 300. As illustrated in FIG. 2, before time 310, that is, during time period 309, the system may exclusively use LTE mode for carrying user plane data. At time 310, however, a secondary cell group addition (“SGCA”) may occur. Then, during time period 312, sub-6 mode may be primarily responsible for communicating user plane data, as sub-6 mode may have greater average downlink speed than LTE. However, during time period 312, LTE mode may continue to be active, as a supplement or back-up to sub-6 for user plane data, to help facilitate reliable and timely data communication.

At time 314, a secondary cell group addition of cells that communicate in mmWave mode may occur. Thus, during time period 316, each of LTE mode 300, sub-6 mode 302, and mmWave mode 304 may remain active for carrying user-plane data. (This may be distinguished from alternative systems where upon connection in mmWave mode, LTE and sub-6 may discontinue carrying user-plane data.) Certainly, using mmWave mode 304 as the primary user data communications mode during time period 316 may be advantageous, given that mmWave mode 304 may have a higher average downlink speed than sub-6 mode 302, which may have a higher average downlink speed than LTE mode 300. However, the “triple connectivity” of all three modes may provide more reliable data communication.

At time 318, the mmWave secondary cell group may be released (a secondary cell group release, or “SCGR”). During time period 320, then, both sub-6 mode 302 and LTE mode 300 may remain active for carrying user-plane data; no reconnection to sub-6 mode 302 or LTE mode 300 would need to occur because connection to those modes is already in place; the result may be a seamless transfer of communications responsibility, without connection/reconnection lags. During time period 320, sub-6 mode 302 may have primary user plane data communication responsibility; LTE mode 300 may be a supplement or back-up.

The sequence illustrated in FIG. 2 may provide advantages over alternative systems where, once a mmWave SCGA occurs, sub-6 and LTE user plane data communication may stop. In such situations, firstly, the mmWave communication may take an undesirable time delay in order to be established and stabilized; this may temporarily inhibit the availability and reliability of communications in the system. Further, then, the sequence of FIG. 2 is also advantageous over such alternative systems when SCGR occurs, as re-establishment of LTE and sub-6 communications in such alternative systems may take an undesirable time delay and, again, the availability and reliability of communications in the system may be inhibited.

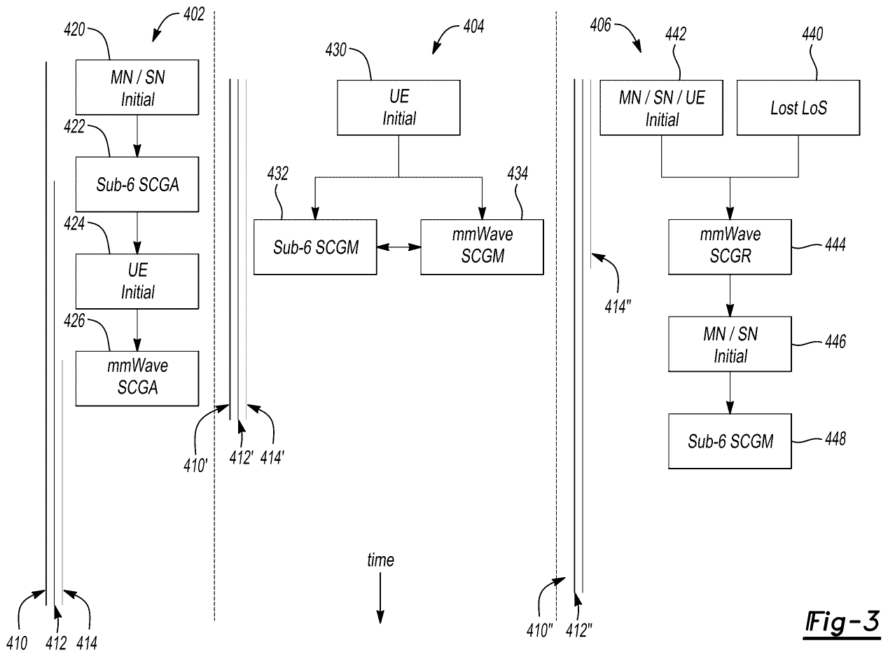

Refer now to FIG. 3, for additional detail of secondary cell group addition (“SCGA”), secondary cell group modification (“SCGM”), and secondary cell group release (“SCGR”). In FIG. 3, user plane data transmission responsibility is indicated by bar 410, bar 410′ or bar 410″ for LTE; bar 412, bar 412′ or bar 412″ for sub-6; and bar 414, bar 414′ or bar 414″ for mmWave.

SCGA 402 may begin with LTE MN/SN master node (“MN”)/secondary node (“SN”) initialization 420, at which point LTE communication may begin. At block 422, a sub-6 secondary cell group may be added. At this point, as reflected by bar 410 and bar 412, sub-6 and LTE user plane communication may be enabled, and such communication may occur with initialization of user equipment 102 at block 424. A mmWave secondary cell group may be added at block 426. As indicated by bar 410, bar 412, and bar 414, communication via mmWave, sub-6, and LTE may each be active at this point.

SCGM (“secondary cell group modification”) 404 may begin with initialization of user equipment 102 at block 430. Secondary cell group modification between sub-6 and mmWave may then occur and be coordinated between block 432 and block 434. Notably, all of mmWave, sub-6, and LTE modes may be active for carrying user plane data, as illustrated by bar 410′, bar 412′, and bar 414′.

SCGM may involve the dynamic reconfiguration of an existing secondary cell group. Modifications may include changing the configuration of secondary cells within the group, such as adjusting bandwidth allocations, path user/control plane flow (adjusting data radio bearer (DRB) or signaling radio bearers (SRB)), or other operational parameters. SCGM may be used when there is a need to optimize the performance of existing connections without adding or removing entire cell groups, often in response to changing network conditions or user demands.

SCGR 406 may begin with loss of line of sight (“LOS”) of mmWave (block 440). MN/SN/UE initialization may occur at block 442. mmWave SCGR may occur at block 444, at which point connection to LTE (bar 410″) and sub-6 (bar 412″) may continue and connection to mmWave (bar 414″) may end. MN/SN initialization may occur at block 446, and sub-6 SCGM at block 448.

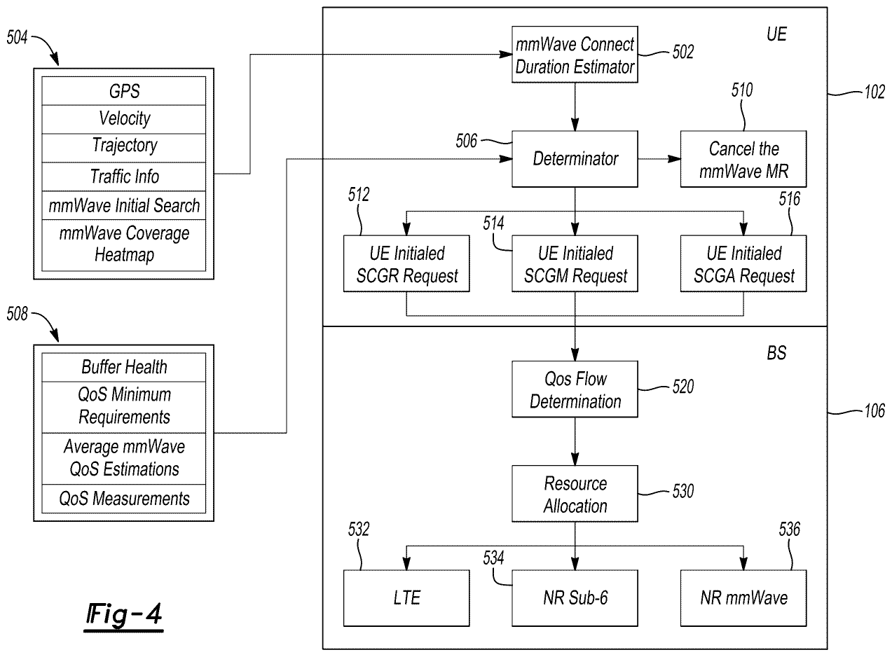

As an additional feature of the system disclosed herein, it is noted that there may be advantages to having user equipment 102 help guide resource allocation and mmWave cell operation decisions made by base stations 106, because user equipment 102 may have knowledge about the quality of service that it needs. Refer now to FIG. 4. mmWave connect duration estimator 502 may use various mobility information 504 that is available to user equipment 102, such as:
Global position satellite (“GPS”) position data for vehicle 104/user equipment 102
Velocity of vehicle 104/user equipment 102
Trajectory of travel of vehicle 104/user equipment 102
Information regarding road traffic
Initial search of mmWave resources available
A coverage “heatmap” of mmWave coverage in the vicinity of vehicle 104/user equipment 102, which may be “crowd sourced” from other connected vehicles in the vicinity

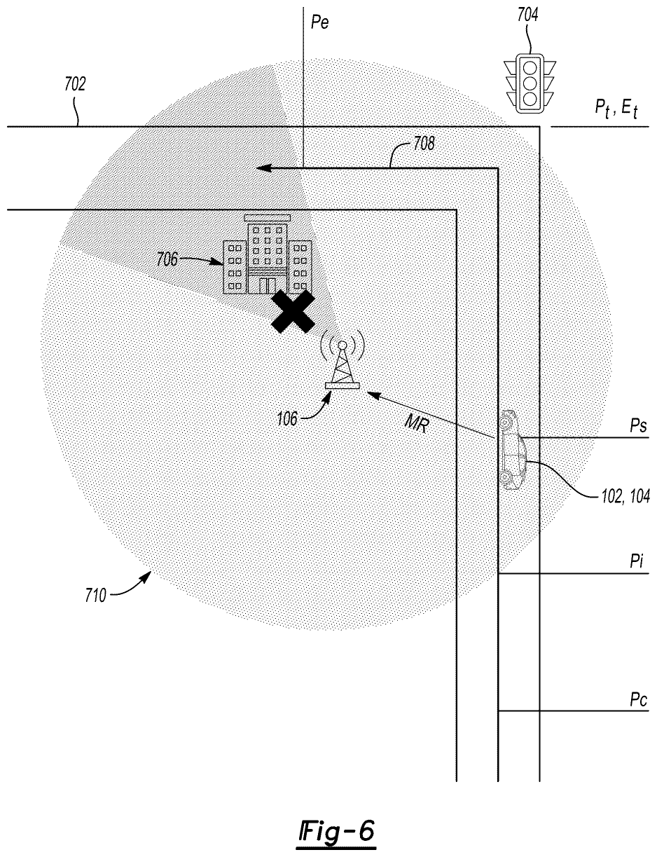

mmWave connect duration estimator 502 may then estimate a time during which user equipment 102 may potentially be connected to mmWave. mmWave connect duration estimator 502 will be described with additional reference to FIG. 6. Illustrated in FIG. 6 are vehicle 104, which may carry user equipment 102, a base station 106, a road 702 on which vehicle 104 (and user equipment 102) travel, a traffic light 704 at an intersection of road 702, and a building 706 that may interfere with the line of sight between user equipment 102 and base station 106, depending upon the location of vehicle 104 during its travel along a route 708. Line of sight may be particularly important for communication via mmWave. Coverage area 710 for mmWave communication is also illustrated in FIG. 6.

There may be two estimation methods, each using information that may be gathered by user equipment 102. In a first estimation method,

$$\begin{matrix}Ta = \frac{d ( Pc , Pe )}{v} + {E}_{a} , \\ and \\ Ts = \frac{d ( P c , P i )}{v} + {E}_{s} \\ Δ T = ( a + b ) - ( mod ( Ts , ( a + b ) ) + max ( 0 , a - ( mod ( Ts , ( a + b ) ) , \\ and \\ T = Ta - T s - Δ T\end{matrix}$$

T is the time that user equipment 102 is estimated to be connected to a mmWave cell.

In the above,
P_{c} is the location where user equipment 102 receives a mmWave Measurement Configuration (“MC”), which instructs the user equipment to search for mmWave connectivity;
Pi is the location where the user equipment enters mmWave coverage;
Pe is the location where user equipment 102 releases at least one mmWave cell, which may occur due to a blockage of the line of sight or moving out of the coverage range;
   Pₜ is the location of traffic signal 704;
   Ea and Es are estimated waiting times due to traffic conditions;
   d(Pc,Pi) is the distance between Pc and Pi;
   d(Pc,Pe) is the distance between Pc and Pe;
   v is the average velocity of user equipment 102;
   a is the search period for a mmWave signal; and
   b is the idle period before the next search period.
      Pᵢ, Pₑ, and Pₜ are highly geographically related and may be estimated using a coverage heatmap, which may be available due to “crowd-sourcing” from other vehicles. In the above, the “mod” function will return the remainder when the first operand is divided by the second operand (that is, “mod(x,y)” will return the remainder when x is divided by y). Further, the “max” function will return the maximum of the two operands (that is, “max(x,y)” will return the maximum of x and y).

The first estimation method, described above, is achieved due to the specific mmWave searching mechanism: base station 106 may instruct user equipment 102 to search for mmWave connectivity every a+b seconds. This first estimation method uses the locations of Pi and Pc, which provide more preparation time for user equipment 102 than a second estimation method, which will be described immediately below.

In the second estimation method that may be performed by mmWave connection duration estimator 502,

$$T = \frac{d ( Ps , Pe )}{v} + E t$$

In the above, Ps is the location where user equipment 102 provides a measurement report (“MR”) triggered by the mmWave cell signal strength meeting a specific condition. This second estimation method, which uses the location of Ps, may be more accurate than the first estimation method. However, the second estimation method may provide less time for preparation than the first estimation method. In the above, Et is an estimated waiting time at traffic signal 704, and d (Ps, Pe) is the distance between Ps and Pe.

Determinator 506 then determines whether to request base station 106 to make a mmWave connection. This may use various data available from user equipment 102 and listed in block 508, including:
Buffer health
Minimum requirements for quality of service
Average estimations of mmWave quality of service
Quality of service measurements

Determinator 506 may operate as follows. If mmWave is not connected, Da is computed as follows:

$${D}_{a} = \frac{g \times {Q}_{min} \times {Q}_{estimate} \times T}{B \times {Q}_{c urrent}}$$

where
Qₘᵢₙ is the normalized minimum quality of service requirement of the application, such as connected automated vehicle (“CAV”);
Qₑₛₜᵢₘₐₜₑ is a normalized estimated quality of service during the mmWave connection;
Q_{current} is the current mmWave quality of service;
T is the estimated duration of user equipment connection to mmWave;
B is the current health of the user equipment buffer, reflecting buffer utilization or availability (scaled from 0 to 1, with higher values indicating lower utilization);
g is the significance factor of mmWave technology to the application in questions (scaled from 0 to 1, with 1 being more important)
   If Dₐ is greater than a calibratable threshold θₐ, then connection may be made to the mmWave cells. If Dₐ is less than the threshold, then user equipment 102 may reject a request from the telecommunications system to connect in mmWave mode (block 510).

Qₑₛₜᵢₘₐₜₑ (that is, estimated quality of service (“QoS”) plays a role as a factor that may influence the decision-making process. A dedicated QoS prediction model may be used to make QoS predictions/estimates during the mmWave connection (from the current time until user equipment 102 leaves mmWave coverage area 710). One of the simplest prediction models is the persistent prediction model, which assumes that the current QoS will remain the same in the near future. Alternatively, using an mmWave heatmap may aid in prediction; for example, if it is understood that user equipment 102 will soon enter a non-line-of-sight zone, Qₑₛₜᵢₘₐₜₑ may adjust to a lower value to reflect the expected degradation in QoS.

On the other hand, if mmWave is connected, determinator 506 may operate as follows. A value D_{r_m} may be calculated:

$${D}_{r\_m} = \frac{1}{g \times B \times {Q}_{min} \times {Q}_{c urrent} \times {Q}_{estimate} \times T}$$

The mmWave cells may be released if D_{r_m}>θᵣ, where θᵣ, is a calibratable threshold. However, if
then

$$\begin{matrix}{θ}_{r} \geq {D}_{r\_m ,} \geq {θ}_{m} \\ {R}_{m m w a v e} = \frac{{θ}_{r} - {D}_{r\_m}}{{θ}_{r} - {θ}_{m}} , \\ and \\ {R}_{s u b 6} = \frac{{D}_{r\_m} - {θ}_{m}}{{θ}_{r} - {θ}_{m}} ,\end{matrix}$$

where
R_{mmWave} and R_{sub6} are proportions of resources allocated to each resource (mmWave and sub-6, respectively).

At block 512 (UE initiated SCGR request), block 514 (UE initiated SCGM request) and block 516 (UE initiated SCGA request), user equipment 102 requests an appropriate release, modification, or addition of mmWave cells, respectively.

Base station 106 next makes a quality of service flow determination at block 520. Conventionally, mobility management may rely on feedback from the user equipment's physical layer information, but this may not be effective for managing quality of service flows, particularly in mmWave environments. Here, however, a feedback system based on the user equipment's application layer (“AL”) information and tailored for mmWave quality of service management may provide improvements.

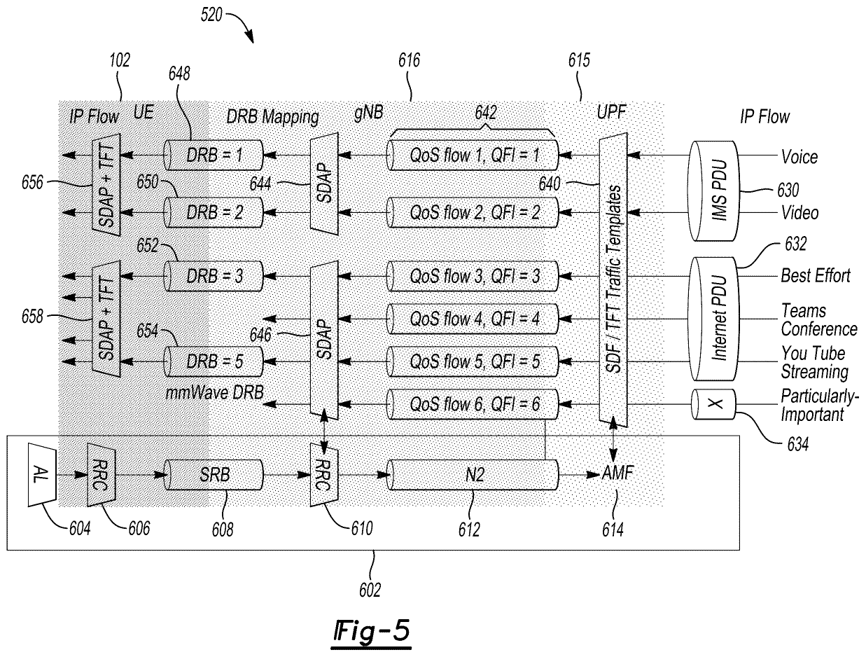

At block 520, which is described in detail at FIG. 5, feedback path 602 is provided for application layer information. Feedback from AL 604 is fed through radio resource control (“RRC”) 606 to signaling radio bearer (“SRB”) 608. SRB 608 carries control plane signaling messages. The feedback continues via RRC 610 to N2 612, which is an interface for control signaling between Next Generation Node B (“gNodeB” or “gNB”) 616 and Access & Mobility Management Function (“AMF”) 614 in the core network (e.g., in base station 106).

IP Flow may include voice and video, which may be routed through an IP Multimedia System Protocol Data Unit (“IMS PDU”) 630. IP Flow may also include Best Effort (where the network will attempt to deliver the data packets as well as it can, but with no performance guarantees), conferencing data (such as from Microsoft™ Teams™ or Zoom™), and YouTube™ streaming, which may be routed through an Internet Protocol Data Unit (“Internet PDU”) 632. Particularly-important data or data that otherwise need certainty of high quality of service and low latency may be provided via a dedicated interface 634. The flow may next proceed to SDF/TFT Traffic Templates 640 in User Plane Function (“UPF”) 615, which are a set of packet filters for classifying service data flows. Quality flow identifiers (“QFIs”) 642 result from the classification, to identify priorities for quality of service of various data. Particularly time-sensitive or particularly important data may be identified with a high QFI, here, QFI=6. Service data adaptation protocol (“SDAP”) 644 and SDAP 646 may map quality of service flows to data radio bearer (“DRB”) 648, DRB 650, DRB 652, and DRB 654. DRB 654 may be a DRB dedicated to mmWave traffic and may, in this example, carry the user plane data associated with the highest two QFI values (QFI=5 and QFI=6). Data may then go to SDAP/TFT 656 and SDAP/TFT 658.

Based on flow determination 520, resources are allocated (block 530) among LTE (block 532), 5G sub-6 (block 534) and 5G mmWave (block 536).

User equipment assisted mmWave mobility management as reflected in FIG. 4 uses the user equipment 102 to guide base station 106 decisions regarding mmWave cell operations. For SCGA, given potential limited coverage of mmWave technology, short connections that could reduce overall performance due to time needed to establish the connections may be avoided. Therefore, user equipment 102 may cause suppression of the mmWave system messaging request in such cases, preventing connections to subsequent mmWave cells. User equipment 102 may also advise base station 106 to modify or release a mmWave cell if poor quality of service is detected by user equipment 102 or if an unhealthy buffer state in user equipment 102 is observed. The recommendation for which cell operation to perform may depend upon the estimated remaining time user equipment 102 is under mmWave coverage. Further, providing an earlier recommendation for SCGR may help prevent potential disconnections in mmWave cells caused by loss of line of sight with base station 106. Additionally, tailored SCGM instructions may enable base station 106 to apply optimized quality of service rules for the current application, such as a CAV application, thereby indirectly influencing the radio access technology (“RAT”) responsible for communicating the data. The system as disclosed herein allows user equipment 102 to have influence over whether user equipment 102 joins a mmWave network; although, while physical signal conditions may be suitable for user equipment 102 to join the mmWave network, and in some current implementations user equipment 102 may be forced to join the mmWave network if the physical signal conditions are suitable, joining the mmWave network may not provide optimum communication.

It should be understood herein that user equipment 102 and base station 106 may be microprocessor-based devices that have sufficient microcomputer resources (microcontroller, memory, software, inputs, outputs, peripherals, and the like) to perform the functions ascribed to them in this disclosure. User equipment 102 and base station 106 may perform the functions based on instructions programmed into software that is executed by user equipment 102 and base station 106. Further, each such instruction may include one or more further instructions.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

What is claimed is:

1. A method for operating a telecommunications system that includes a plurality of base stations, the method comprising:
through user equipment:
estimating a time of connection of the user equipment to the telecommunications system in a first communications mode;
if the estimated time of connection is below a threshold and the user equipment is not connected to the telecommunication system in the first communications mode, rejecting a request from the telecommunication system to the user equipment for the user equipment to connect to the telecommunication system in the first communications mode; and
if the user equipment is connected to the telecommunications system, providing a request, using the estimated time of connection, to the telecommunications system regarding one or more operations of the telecommunications system.

2. The method of claim 1, wherein the one or more operations of the telecommunications system include an addition of a secondary cell group.

3. The method of claim 1, wherein:
the first communications mode is a millimeter wave (“mmWave”) communications mode; and
the estimated time of connection is a function of Ps, Pe, and v, where Ps is a location where the user equipment provides a measurement report to telecommunications system, Pe is a location where the user equipment releases at least one mmWave cell, and v is an average velocity of the user equipment.

4. The method of claim 1, wherein the one or more operations of the telecommunications system include a release of a secondary cell group.

5. The method of claim 1, wherein:
the first communications mode is a mmWave communications mode; and
the estimated time of connection is a function of P_{c}, Pe, Pi and v, where P_{c} is a location where the user equipment receives a millimeter-wave measurement configuration, Pe is a location where the user equipment releases at least one mmWave cell, Pi is a location where the user equipment enters mmWave coverage, and v is an average velocity of the user equipment.

6. The method of claim 1, further comprising:
through the user equipment, feeding back application layer data of the user equipment to at least one of the base stations; and
through the at least one base station, using the application layer data to control a quality of service flow in the telecommunications system.

7. The method of claim 6, further comprising:
through the at least one base station, allocating communication resources among multiple communication modes.

8. The method of claim 7, wherein the multiple communication modes include Long-Term Evolution (“LTE”), 5G sub-6 gigahertz (“sub-6”) and 5G mmWave.

9. A method of operating a cellular telecommunication system for communication with user equipment, the method comprising:
operating in a first communications mode and a second communications mode, the second communications mode being a backup or supplement for communications in the first communications mode;
adding one or more secondary cell groups operating in a third communications mode; and
after adding the one or more secondary cell groups, communicating in the first communications mode, the second communications mode, and the third communications mode.

10. The method of claim 9, wherein the first communications mode has a higher average downlink throughput than the second communications mode.

11. The method of claim 10, wherein the secondary cell groups operate at a higher average downlink throughput than the first communications mode and the second communications mode.

12. The method of claim 9, wherein:
the first communications mode is a 5G sub-6 communication mode;
the second communications mode is an LTE communication mode; and
the secondary cell groups operate in a mmWave communication mode.

13. The method of claim 9, wherein:
the first communications mode is 5G sub-6 communication mode; and
the second communications mode is LTE communication mode.

14. The method of claim 9, wherein:
the first communications mode carries control plane data used to control the cellular telecommunications system and carries first user plane data of the user equipment;
the second communications mode carries second user plane data of the user equipment; and
the third communications mode carries third user plane data of the user equipment.

15. The method of claim 9, wherein the cellular telecommunications system includes one or more base stations.

16. The method of claim 15, wherein the user equipment is mobile.

17. A vehicle comprising:
user equipment operable for communication via a telecommunications system; and
a controller programmed with and operable to execute the following instructions:
estimate a time of connection of the user equipment to the telecommunications system in a first communications mode;
if the estimated time of connection is below a threshold and the user equipment is not connected to the telecommunication system in the first communications mode, reject a request from the telecommunication system to the user equipment for the user equipment to connect to the telecommunication system in the first communications mode; and
if the user equipment is connected to the telecommunications system in the first communications mode, provide a request, using the estimated time of connection, to the telecommunications system regarding one or more operations of the telecommunications system.

18. The vehicle of claim 17, wherein the controller is further programmed with and operable to execute an instruction to feed back application layer data of the user equipment to the telecommunications system.

19. The vehicle of claim 17, wherein the first communications mode is 5G millimeter wave.

20. The vehicle of claim 19, wherein the one or more operations include secondary cell group addition (“SCGA”).
